(19) United States
(12) Patent Application Publication
(10) Pub. No.: US 2014/0215308 A1
(43) Pub. Date: Jul. 31, 2014

(54) Web Page Reflowed Text

(71) Applicant: ADOBE SYSTEMS INCORPORATED, San Jose, CA (US)

(72) Inventors: Christian T. Cantrell, Sterling, VA (US); Vincent Julien Hardy, Palo Alto, CA (US)

(73) Assignee: ADOBE SYSTEMS INCORPORATED, San Jose, CA (US)

(21) Appl. No.: 13/756,228

(22) Filed: Jan. 31, 2013

(51) Int. Cl. G06F 17/22

(52) U.S. Cl. CPC G06F 17/2247
USPC 715/234

(57) ABSTRACT

In embodiments of Web page reflowed text, a computing device can display a Web page in a browser application interface, where the Web page includes displayable text. The computing device implements a text reflow browser extension to determine a size of a viewable area in which the Web page is displayable in the browser application interface. The text reflow browser extension can also determine a column display layout effective to organize the displayable text of the Web page for optimal readability in the viewable area of the browser application interface. The text reflow browser extension can then create columns of the column display layout, and redistribute the displayable text into the columns of the column display layout for display in the browser application interface.

### BACKGROUND

Many types of devices can be used to access and display Web page content for viewing, such as with computer devices, entertainment devices, and mobile devices, such as tablets and mobile phones. Typically, a user with a device can access the Internet to download and view Web page content from many different Web sites. However, Web pages that are downloaded for display and viewing typically do not take into account many of the display conditions, such as the various screen sizes and resolution of different display devices on which the Web pages may be displayed for viewing.

Additionally, Web pages may not be optimized for readability and are typically formatted in a vertical orientation so that a user has to scroll vertically to navigate, view, and read the Web page content. In particular, text in a Web page often spans a single, wide text box, and a user may have to scroll not only vertically, but also horizontally to read the text. Reading can be difficult when a reader's eyes travel a long distance across a wide text box, and while the text content is scrolled, which can make it difficult to maintain one's place while reading. People typically read more efficiently when text is arranged in narrow columns and when they can “page” through content rather than scroll. Some techniques attempt to make content distraction-free and easier to read by removing the distractions, such as banners, advertisements, and navigation links, as well as by increasing font sizes, simplifying styles and font usage, and arranging text in a single vertical column. However, these techniques to improve the readability of Web page content does not amount to an optimal experience for reading text that is displayed in a Web page.

### SUMMARY

This Summary introduces features and concepts of Web page reflowed text, which is further described below in the Detailed Description and/or shown in the Figures. This Summary should not be considered to describe essential features of the claimed subject matter, nor used to determine or limit the scope of the claimed subject matter.

Web page reflowed text is described. In embodiments, a computing device can display a Web page in a browser application interface, where the Web page includes displayable text. The computing device implements a text reflow browser extension to determine a size of a viewable area in which the Web page is displayable in the browser application interface. The text reflow browser extension can also determine a column display layout effective to organize the displayable text of the Web page for optimal readability in the viewable area of the browser application interface. The text reflow browser extension can then create columns of the column display layout, and redistribute the displayable text into the columns of the column display layout for display in the browser application interface.

In embodiments, the text reflow browser extension can determine a display orientation of the viewable area in the browser application interface, and then determine the column display layout based on the size and the display orientation of the viewable area in the browser application interface. The text reflow browser extension can group the columns of the column display layout into text pages that are sequentially navigable with page navigation inputs, such as with page-up and page-down user inputs, or with other content navigation inputs (e.g., user-selectable controls, or a drag, swipe, or other gesture input) to view the text pages. A Web page may also include non-displayed text in an initial display of the Web page (e.g., outside of the viewable area in the browser application interface), and the text reflow browser extension can distribute the non-displayed text into the columns of the column display layout after the displayable text redistribution.

In embodiments, the text reflow browser extension can receive an input on the browser application interface to initiate a redistribution of the displayable text into the columns of the column display layout. For example, the text reflow browser extension can receive a user input to select a pagination format template of the column display layout, receive a user input to designate a quantity of the columns to create in the column display layout, or receive a user input to designate a column width. A user input to designate a column width can be received as a measured column width (e.g., in inches, millimeters, etc.), as a number of text characters, as a typographical unit of measure (“em”), as a number of pixels, and the like. The text reflow browser extension can then determine a quantity of the columns to create based on the designated column width. The text reflow browser extension may also receive a user input to designate a user priority for having the text reflowed, such as the column width, or the number of columns. The text reflow browser extension can then determine the number of columns based on the designated column width, or determine the column width based on the designated number of columns.

### BRIEF DESCRIPTION OF THE DRAWINGS

Embodiments of Web page reflowed text are described with reference to the following Figures. The same numbers may be used throughout to reference like features and components that are shown in the Figures:

FIG. 1 illustrates an example system in which embodiments of Web page reflowed text can be implemented.

FIG. 2 illustrates an example of Web page reflowed text in accordance with one or more embodiments.

FIG. 3 illustrates an example of Web page reflowed text in accordance with one or more embodiments.

FIG. 4 illustrates example method(s) of Web page reflowed text in accordance with one or more embodiments.

FIG. 5 illustrates an example system with an example device that can implement embodiments of Web page reflowed text.

### DETAILED DESCRIPTION

Embodiments of Web page reflowed text are described and may be implemented in any type of device that supports a browser application to facilitate a user viewing media content, such as Web pages on a mobile phone, tablet, computing, communication, entertainment, gaming, media playback, and/or other type of device. A text reflow browser extension is implemented to determine a column display layout that is effective to organize Web page text into columns for optimal readability in a viewable area of a browser application interface in which the Web page is displayed for viewing. The text reflow browser extension can determine the column display layout based on the size and display orientation of the viewable area in the browser application interface, as well as based on the text content itself, the screen size and resolution of a display device, and/or user selectable reflow and pagination format templates. A redistribution of the Web page text can be initiated by a user of a device to apply various template layouts and text reflow choices, and the reflowed Web page text is easier and more efficient for the user to read and navigate.

While features and concepts of Web page reflowed text can be implemented in any number of different devices, systems, networks, environments, and/or configurations, embodiments of Web page reflowed text are described in the context of the following example devices, systems, and methods.

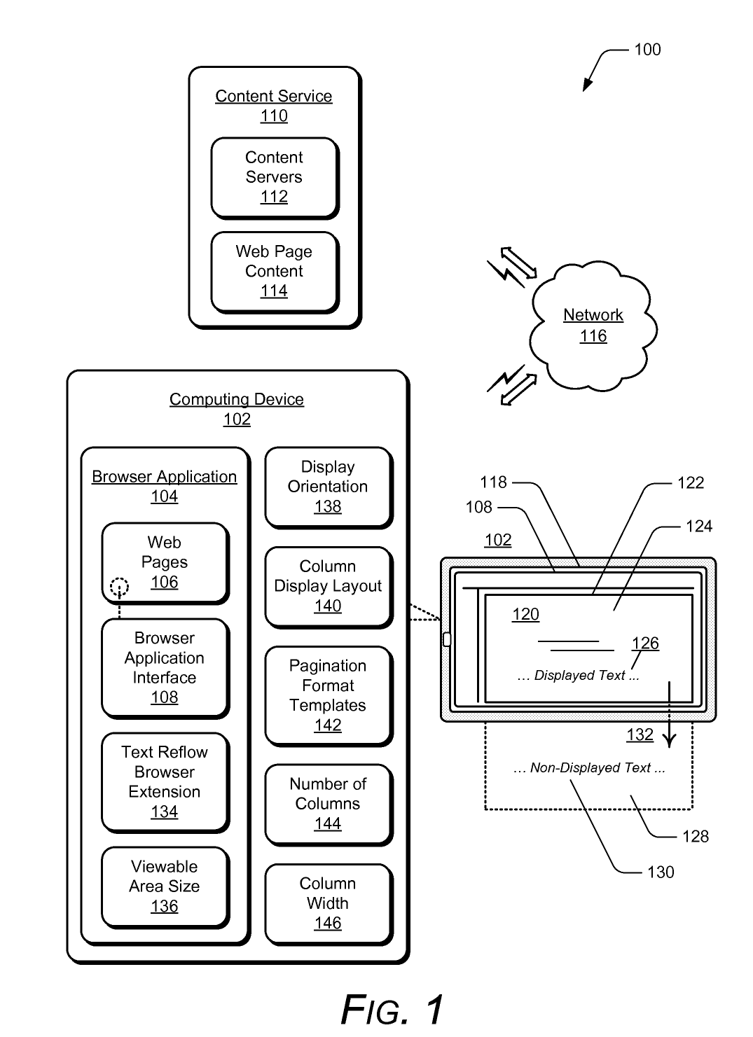

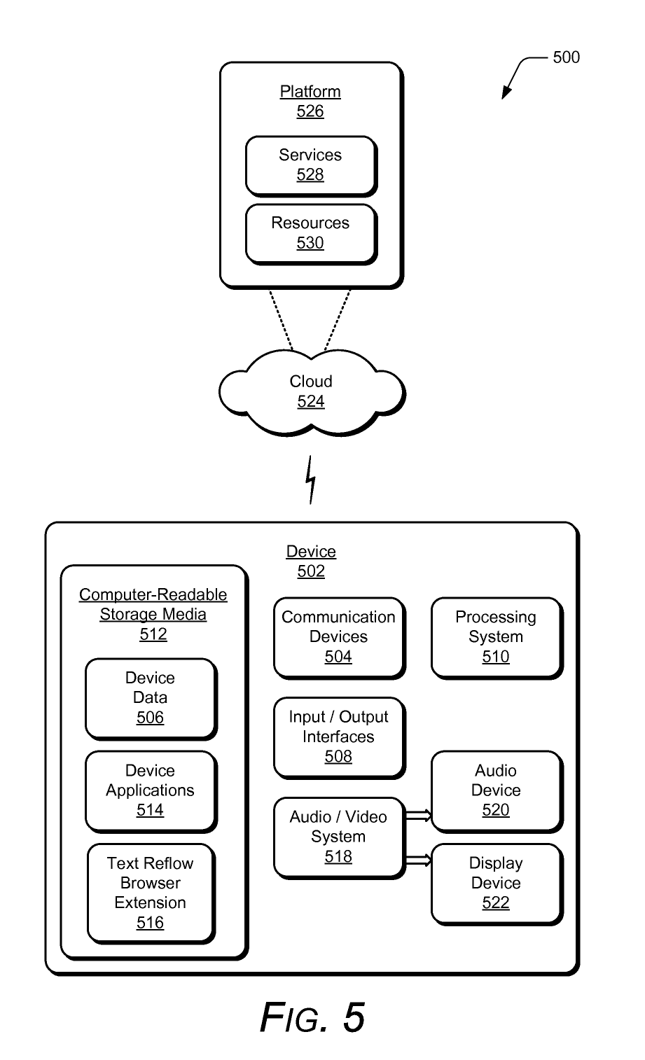

FIG. 1 illustrates an example system 100 in which embodiments of Web page reflowed text can be implemented. The system 100 includes an example computing device 102 that includes a browser application 104 to support a user of the device viewing Web pages 106 via a browser application interface 108. The example device may be any one or combination of a wired or wireless device, such as a mobile phone, tablet, computing, communication, entertainment, gaming, media playback, and/or other type of device. Any of the devices can be implemented with various components, such as a processing system and memory, as well as any number and combination of differing components as further described with reference to the example device shown in FIG. 5.

The example system 100 also includes a content service 110 that implements content servers 112 to distribute Web page content 114 to client devices that request the Web page content for display and viewing, such as Web pages for various Web sites. The content service 110 is representative of any Internet media content provider, such as any type of Web site that a user of the computing device 102 can navigate, visit, and request the Web page content for download and viewing as the Web pages 106 at the computing device 102.

Any of the devices and servers described herein can communicate via a network 116, which can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

In this example, the computing device 102 includes an integrated display device 118 to display the browser application interface 108 (e.g., a user interface of the browser application) through which the Web pages 106 are displayed for viewing. For example, a Web page 120 is displayed for viewing on the display device 118 in a viewable area 122 of the browser application interface. The viewable area in which a Web page is displayed may be smaller than the physical display area of the integrated display device 118 and/or smaller than the display of the browser application interface itself

A Web page (also referred to as a Web document) may not be completely displayed at a computing device. Although a desktop computer may have a large peripheral display device that can display a complete Web page for viewing, a mobile device, such as a mobile phone or tablet device, can typically only display part of a Web page on a smaller display device. A user can then scroll to view more of a Web page that is not completely displayed for viewing. In this example, part of the Web page 120 is displayed at 124 in the viewable area 122 of the browser application interface 108 and includes displayed text 126, while more of the Web page is not displayed at 128 and includes non-displayed text 130. A user of the computing device 102 can then scroll down at 132 to view the non-displayed text and the other non-displayed part of the Web page.

The computing device 102 includes a text reflow browser extension 134 that can be implemented as a software application, module, script, or component to extend the functionality of the browser application 104. A browser extension can be created much like a Web page, utilizing HTML, style sheets, images, and scripts designed to access Web page code and content, and extend browser functionality. The text reflow browser extension can be maintained at the computing device 102 as executable instructions that are stored on computer-readable storage media, such as any suitable memory device or electronic data storage as described with reference to the example device shown in FIG. 5. Additionally, the text reflow browser extension can be executed with a processing system at the computing device to implement embodiments of Web page reflowed text. Although described and illustrated as client device techniques, embodiments of Web page reflowed text may be implemented as server techniques to reflow Web page text of Web page content that is then downloaded to a client device, such as to the computing device 102. For example, the content service 110 may implement the text reflow browser extension 134 as described herein to reflow Web page text of the Web page content 114.

The text reflow browser extension 134 is implemented to determine a size 136 of the viewable area 122 in which a Web page is displayed, and optionally, may determine a display orientation 138 (e.g., portrait or landscape) of the viewable area in the browser application interface 108. The text reflow browser extension can then determine a column display layout 140 based on the size and/or display orientation of the viewable area in the browser application interface. The text reflow browser extension can also determine the column display layout based on other factors or parameters, such as based on the text content itself, the screen size of the display device 118, and/or the resolution of the display device, to include the dots per inch (DPI) and/or pixels per inch (PPI) of the display device. The text reflow browser extension determines the column display layout effective to organize the displayed text 126 of the Web page for optimal readability in the viewable area of the browser application interface.

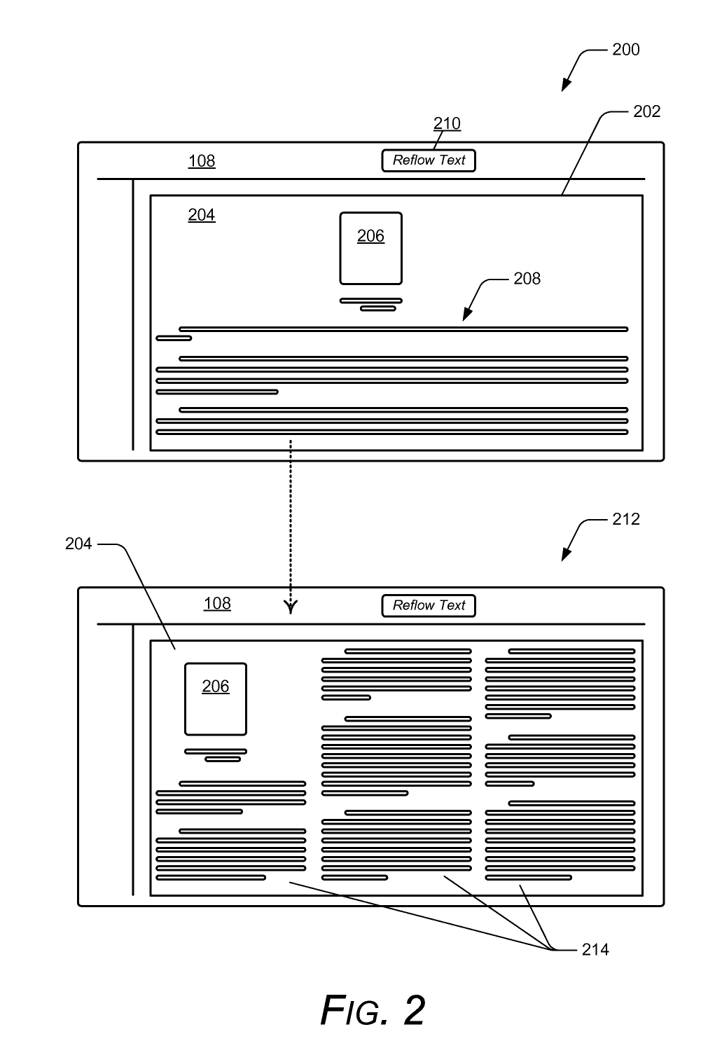

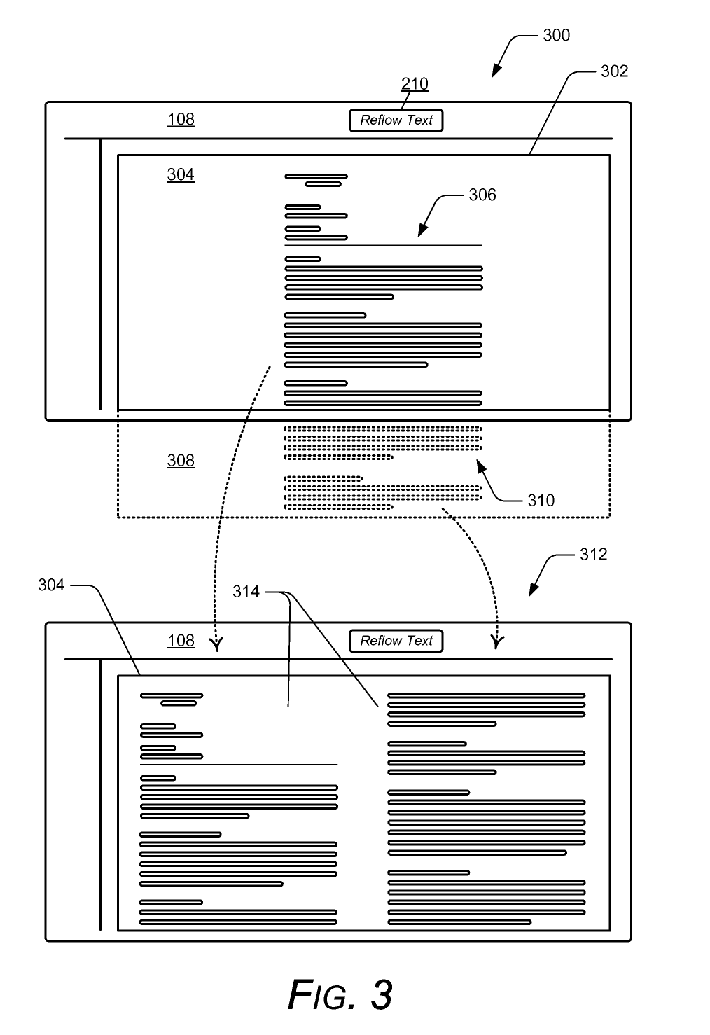

The text reflow browser extension 134 can then create columns of the column display layout, and redistribute the displayed text into the columns for display in the browser application interface. An example of this is illustrated and described with reference to FIG. 2. For a Web page that includes non-displayed text 130, such as the part of the Web page that is not displayed at 128, the text reflow browser extension can distribute the non-displayed text into the columns of the column display layout after the displayed text redistribution. An example of this is illustrated and described with reference to FIG. 3. The text reflow browser extension can then group the columns of the column display layout into text pages that are sequentially navigable with page navigation inputs, such as with page-up and page-down user inputs to view the text pages.

A redistribution of the displayed text and/or the non-displayed text of a Web page can also include moving the display location of pictures, images, tables, and the like that are associated with the Web page text, as well as navigation links (also referred to as hyperlinks or document anchors) that are moved for text redistribution. Some forms of content may also be split across columns, while other forms of content are not. For example, an image would not be split between columns, but a table could be. Additionally, the text reflow browser extension 134 can maintain relationships between objects, such as images and captions that are associated with the images. The text reflow browser extension 134 is also implemented to maintain the continuity of the navigation links for text redistribution. For example, a navigation link in the table of contents of a document may initially redirect a user to page five of the document, and after text redistribution, correctly redirect the user to page four of the document. The text reflow browser extension can also translate between a vertical scrolling location for a hyperlink and a page number of the content.

The browser application interface 108 can include user-selectable input controls that initiate browser extensions, such as to initiate the text reflow browser extension 134 for redistribution of the displayed text 126 and/or the non-displayed text 130 of the Web page 120 into the columns of the column display layout 140. Alternatively or in addition, the text reflow browser extension can receive a user input to select a reflow and/or pagination format template 142 of the column display layout, or a user input to designate a number 144 (e.g., quantity) of the columns to create in the column display layout. A user input may also designate a column width 146 as any number of different unit types, such as a measured column width (e.g., in inches, millimeters, etc.), as a number of text characters, as a typographical unit of measure (“em”), as a number of pixels, and the like. The text reflow browser extension can then determine the number of columns to create based on the designated column width. The text reflow browser extension may also receive a user input to designate a user priority for having the text reflowed, such as the column width, or the number of columns. The text reflow browser extension can then determine the number of columns based on the designated column width, or determine the column width based on the designated number of columns.

FIG. 2 illustrates an example 200 of Web page reflowed text. The browser application interface 108 (described with reference to FIG. 1) includes a viewable area 202 in which a Web page 204 is displayed for viewing. In this example, the Web page is representative of a document or news article that includes an image 206, such as a photo or any other type of image. The Web page also includes displayed text 208 in a typical single, wide text box format. As described above, it can be difficult to read text that that spans the entire width of the viewable area when displayed for viewing, and a user may have to scroll not only vertically, but also horizontally to read the text, which can make it difficult to keep one's place while reading.

The browser application interface 108 includes a user-selectable input control 210, which a user can select to initiate a redistribution of the displayed text 208 into columns of a column display layout. As shown at 212, the text reflow browser extension 134 (described with reference to FIG. 1) can determine a column display layout of the Web page 204 that includes columns 214 in the viewable area 202 of the browser application interface. The text reflow browser extension can then redistribute the displayed text 208 into the columns 214 of the column display layout for the Web page displayed in the browser application interface. Although three columns 214 are shown in this example, the column display layout determined by the text reflow browser extension may include any number of columns effective to organize the displayed text 208 of the Web page for optimal readability in the viewable area of the browser application interface.

Further, although the three columns 214 are shown in this example as being approximately the same width, the columns may be different widths in different templates for column display layouts. Additionally, a user may associate some of the Web content on a Web page to particular columns of a template layout, where these columns are a different width than the rest of the layout. The different widths of a template layout may be dependent on the type of Web page content. For example, if a Web page has a vertical menu as well as the main displayed text 208, a template layout may have a narrow column for the menu content and another, different width column for the main displayed text. When the menu content has been reflowed, the template can transition to the three columns for the rest of the main displayed text.

FIG. 3 illustrates another example 300 of Web page reflowed text. The browser application interface 108 (described with reference to FIG. 1) includes a viewable area 302 in which a Web page 304 is displayed for viewing. In this example, the Web page includes displayed text 306 in a typical vertical orientation that would have a user scroll vertically to navigate, view, and read the Web page content. As described above, it can be difficult to read Web page text while scrolling, which can make it difficult to keep one's place while reading. This example also illustrates that part of the Web page 304 is displayed in the viewable area 302 of the browser application interface 108 and includes the displayed text 306, while more of the Web page is not displayed at 308 and includes non-displayed text 310.

The browser application interface 108 includes the user-selectable input control 210, which a user can select to initiate a redistribution of the displayed text 306 and the non-displayed text 310 into columns of a column display layout. As shown at 312, the text reflow browser extension 134 (described with reference to FIG. 1) can determine a column display layout of the Web page 304 that includes columns 314 in the viewable area 302 of the browser application interface. The text reflow browser extension can then redistribute the displayed text 306 and the non-displayed text 310 into the columns 314 of the column display layout for the Web page displayed in the browser application interface. Although only two columns 314 are shown in this example, the column display layout determined by the text reflow browser extension may include any number of columns effective to organize the displayed text 306 and the non-displayed text 310 of the Web page for optimal readability in the viewable area of the browser application interface.

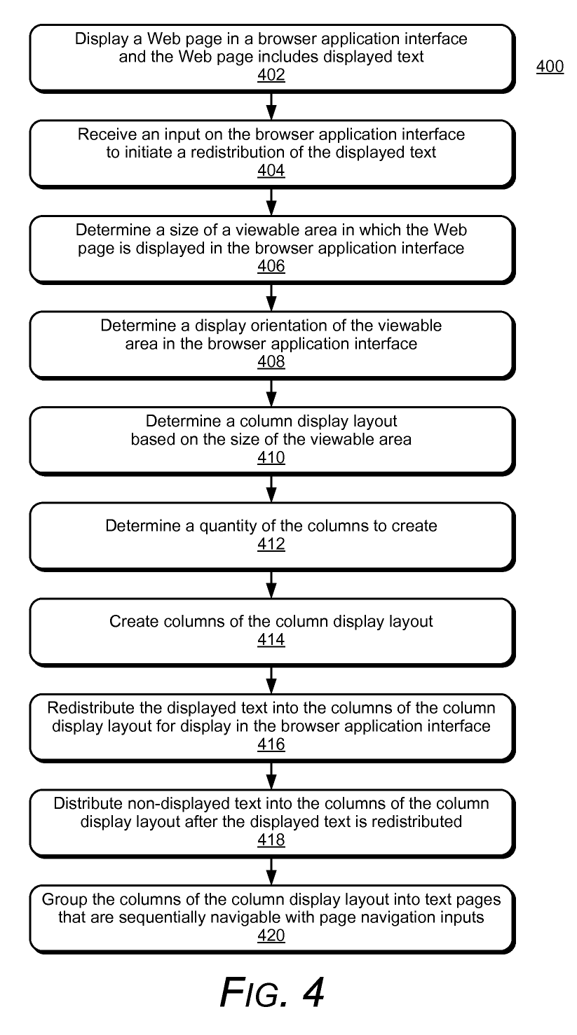

Example method 400 is described with reference to FIG. 4 in accordance with one or more embodiments of Web page reflowed text. Generally, any of the services, components, modules, methods, and operations described herein can be implemented using software, firmware, hardware (e.g., fixed logic circuitry), manual processing, or any combination thereof. Example methods may be described in the general context of executable instructions stored on computer-readable storage media that is local and/or remote to a computer processing system, and implementations can include software applications, programs, functions, and the like.

FIG. 4 illustrates example method(s) 400 of Web page reflowed text, and is generally described with reference to a text reflow browser extension. The order in which the method is described is not intended to be construed as a limitation, and any number or combination of the method operations can be combined in any order to implement a method, or an alternate method.

At 402, a Web page is displayed in a browser application interface and the Web page includes displayed text. For example, the computing device 102 (FIG. 1) includes the integrated display device 118 to display the browser application interface 108 through which the Web pages 106 are displayed for viewing, such as the Web page 120, part of which is displayed in the viewable area 122 of the browser application interface 108 and includes the displayed text 126, while more of the Web page is not displayed and includes the non-displayed text 130. Similarly, a Web page 204 (FIG. 2) is displayed for viewing in a viewable area 202 of the browser application interface, and includes the displayed text 208. Additionally, a Web page 304 (FIG. 3) is displayed for viewing in a viewable area 302 of the browser application interface, and includes the displayed text 306, while more of the Web page is not displayed at 308 and includes the non-displayed text 310.

At 404, an input is received on the browser application interface to initiate a redistribution of the displayed text. For example, the text reflow browser extension 134 at the computing device 102 receives an input on the browser application interface 108 to initiate a redistribution of displayed text into columns of a column display layout 140. The browser application interface 108 includes the user-selectable input control 210, which a user can select to initiate a redistribution of the displayed text 208 into the columns 214 of the column display layout for the Web page 204. Similarly, a user can initiate a redistribution of the displayed text 306 and the non-displayed text 310 into the columns 314 of the column display layout for the Web page 304. As an optional alternative, the text reflow browser extension may initiate an automatic redistribution of the displayed text (e.g., without user input) into columns of a column display layout 140.

The text reflow browser extension 134 can also receive a user input to select a pagination format template 142 of a column display layout, receive a user input to designate a number 144 (e.g., quantity) of the columns to create in a column display layout, or receive a user input to designate a column width 146. A user input to designate a column width can be received as a measured column width (e.g., in inches, millimeters, etc.), as a number of text characters, as a typographical unit of measure (“em”), as a number of pixels, and the like.

At 406, a size of a viewable area in which the Web page is displayed in the browser application interface is determined and, optionally at 408, a display orientation of the viewable area in the browser application interface is determined For example, the text reflow browser extension 134 at the computing device 102 determines the size 136 of the viewable area 122 in which a Web page 106 is displayed, as well as the display orientation 138 (e.g., portrait or landscape) of the viewable area in the browser application interface 108. Additionally, the text reflow browser extension may also determine the screen size of the display device 118, and/or the resolution of the display device at the computing device, to include the dots per inch (DPI) and/or pixels per inch (PPI) of the display device.

At 410, a column display layout is determined based on the size of the viewable area in the browser application interface. For example, the text reflow browser extension 134 at the computing device 102 determines a column display layout 140 based on the size of the viewable area 122 in the browser application interface 108. The text reflow browser extension can also determine the column display layout based on other factors or parameters, such as based on the text content itself, the screen size of the display device 118, the display orientation, and/or the resolution of the display device at the computing device. The column display layout 140 is determined effective to organize the displayed text 126 and/or the non-displayed text 130 of the Web page 120 for optimal readability in the viewable area of the browser application interface. Similarly, the column display layout of the Web page 204 includes the three columns 214 effective to organize the displayed text 208 for optimal readability. Additionally, the column display layout of the Web page 304 includes the two columns 314 effective to organize the displayed text 306 and the non-displayed text 310 for optimal readability.

At 412, a quantity of the columns to create is determined. For example, the text reflow browser extension 134 at the computing device 102 determines the quantity of columns to create, such as based on the column display layout 140 (determined at 410), or based on a user input (received at 404) to select a pagination format template 142 of a column display layout, to designate a number 144 (e.g., quantity) of the columns to create in a column display layout, or to designate a column width 146 as a number of text characters, from which the text reflow browser extension determines the quantity of the columns to create. The text reflow browser extension 134 can receive a user input to designate a user priority for having the text reflowed, such as the column width, or the number of columns. The text reflow browser extension can then determine the number of columns based on the designated column width, or determine the column width based on the designated number of columns.

At 414, columns of the column display layout are created. For example, the text reflow browser extension 134 at the computing device 102 creates the columns of the column display layout 140, such as the three columns 214 for the column display layout of the Web page 204, and the two columns 314 for the column display layout of the Web page 304.

At 416, the displayed text is redistributed into the columns of the column display layout for display in the browser application interface and, at 418, non-displayed text is distributed into the columns of the column display layout after the displayed text is redistributed into the columns. For example, the text reflow browser extension 134 at the computing device 102 redistributes the displayed text 208 into the columns 214 of the column display layout for the Web page 204 that is displayed in the browser application interface 108. Similarly, the text reflow browser extension redistributes the displayed text 306 and the non-displayed text 310 into the columns 314 of the column display layout for the Web page 304 displayed in the browser application interface.

At 420, the columns of the column display layout are grouped into text pages that are sequentially navigable with page navigation inputs. For example, the text reflow browser extension 134 at the computing device 102 groups the columns 214 of the column display layout for the Web page 204 into text pages that are sequentially navigable with page navigation inputs, such as with page-up and page-down user inputs to view the text pages. Similarly, the columns 314 of the column display layout for the Web page 304 are grouped into text pages that are sequentially navigable with page navigation inputs.

FIG. 5 illustrates an example system 500 that includes an example device 502, which can implement embodiments of Web page reflowed text. The example device 502 can be implemented as any of the devices and/or servers described with reference to the previous FIGS. 1-4, such as any type of client device, mobile phone, tablet, computing, communication, entertainment, gaming, media playback, and/or other type of device. For example, the computing device 102, content service 110, and/or a content server 112 shown in FIG. 1 may be implemented as the example device 502.

The device 502 includes communication devices 504 that enable wired and/or wireless communication of device data 506, such as media content and the Web page content that is downloaded and displayed for viewing at the device. The media content can include any type of audio, video, and/or image data. The communication devices 504 can also include transceivers for cellular phone communication and for network data communication.

The device 502 also includes input/output (I/O) interfaces 508, such as data network interfaces that provide connection and/or communication links between the device, data networks, and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of audio, video, and/or image data received from any content and/or data source.

The device 502 includes a processing system 510 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 502 may further include any type of a system bus or other data and command transfer system that couples the various components within the device. A system bus can include any one or combination of different bus structures and architectures, as well as control and data lines.

The device 502 also includes computer-readable storage media 512, such as data storage devices that can be accessed by a computing device, and that provide persistent storage of data and executable instructions (e.g., software applications, programs, functions, and the like). Examples of computer-readable storage media include volatile memory and non-volatile memory, fixed and removable media devices, and any suitable memory device or electronic data storage that maintains data for computing device access. The computer-readable storage media can include various implementations of random access memory (RAM), read-only memory (ROM), flash memory, and other types of storage media in various memory device configurations.

The computer-readable storage media 512 provides storage of the device data 506 and various device applications 514, such as an operating system that is maintained as a software application with the computer-readable storage media and executed by the processing system 510. The device applications also include a browser application and, in this example, a text reflow browser extension 516 that implements embodiments of Web page reflowed text, such as when the example device 502 is implemented as the computing device 102 shown in FIG. 1. An example of the text reflow browser extension 516 is the text reflow browser extension 134 at the computing device 102, as described with reference to FIG. 1.

The device 502 also includes an audio and/or video system 518 that generates audio data for an audio device 520 and/or generates display data for a display device 522. The audio device and/or the display device include any devices that process, display, and/or otherwise render audio, video, display, and/or image data. In implementations, the audio device and/or the display device are integrated components of the example device 502. Alternatively, the audio device and/or the display device are external, peripheral components to the example device.

In embodiments, at least part of the techniques described for Web page reflowed text may be implemented in a distributed system, such as over a “cloud” 524 in a platform 526. The cloud 524 includes and/or is representative of the platform 526 for services 528 and/or resources 530. For example, the services 528 may include the content service 110 as described with reference to FIG. 1. Additionally, the resources 530 may include the Web page content 114 and an implementation of the text reflow browser extension as described with reference to FIG. 1.

The platform 526 abstracts underlying functionality of hardware, such as server devices (e.g., included in the services 528) and/or software resources (e.g., included as the resources 530), and connects the example device 502 with other devices, servers, etc. The resources 530 may also include applications and/or data that can be utilized while computer processing is executed on servers that are remote from the example device 502. Additionally, the services 528 and/or the resources 530 may facilitate subscriber network services, such as over the Internet, a cellular network, or Wi-Fi network. The platform 526 may also serve to abstract and scale resources to service a demand for the resources 530 that are implemented via the platform, such as in an interconnected device embodiment with functionality distributed throughout the system 500. For example, the functionality may be implemented in part at the example device 502 as well as via the platform 526 that abstracts the functionality of the cloud 524.

Although embodiments of Web page reflowed text have been described in language specific to features and/or methods, the appended claims are not necessarily limited to the specific features or methods described. Rather, the specific features and methods are disclosed as example implementations of Web page reflowed text.

1. A computing device, comprising:
a display device configured to display a Web page in a browser application interface, the Web page including displayable text;
a processing system to implement a text reflow browser extension that is configured to:
determine a size of a viewable area in which the Web page is displayable in the browser application interface;
determine a column display layout effective to organize the displayable text of the Web page for optimal readability in the viewable area of the browser application interface;
create columns of the column display layout; and
redistribute the displayable text into the columns of the column display layout for display in the browser application interface.

2. A computing device as recited in claim 1, wherein the text reflow browser extension is configured to:
determine a display orientation of the viewable area in the browser application interface; and
said determine the column display layout based on at least the size and the display orientation of the viewable area in the browser application interface.

3. A computing device as recited in claim 1, wherein the text reflow browser extension is configured to receive an input on the browser application interface to initiate a redistribution of the displayable text into the columns of the column display layout.

4. A computing device as recited in claim 3, wherein the input is a user input to select a pagination format template of the column display layout.

5. A computing device as recited in claim 3, wherein the input is a user input to designate a quantity of the columns to create in the column display layout.

6. A computing device as recited in claim 3, wherein the input is a user input to designate a column width as a number of text characters, and wherein the text reflow browser extension is configured to determine a quantity of the columns to create based on the designated column width.

7. A computing device as recited in claim 1, wherein:
the Web page includes non-displayed text in an initial display of the Web page in the browser application interface; and
the text reflow browser extension is configured to distribute the non-displayed text into the columns of the column display layout after the displayable text redistribution.

8. A computing device as recited in claim 1, wherein the text reflow browser extension is configured to group the columns of the column display layout into text pages that are sequentially navigable with page navigation inputs.

9. A method, comprising:
determining a size of a viewable area in which a Web page is displayed in a browser application interface, the Web page including displayed text;
determining a column display layout based on at least the size and the display orientation of the viewable area in the browser application interface;
creating columns of the column display layout; and
redistributing the displayed text into the columns of the column display layout for display in the browser application interface.

10. A method as recited in claim 9, wherein said determining the column display layout is effective to organize the displayed text of the Web page for optimal readability in the viewable area of the browser application interface.

11. A method as recited in claim 9, further comprising:
receiving an input on the browser application interface to initiate a redistribution of the displayed text into the columns of the column display layout.

12. A method as recited in claim 11, wherein said receiving the input includes receiving a user input to select a pagination format template of the column display layout.

13. A method as recited in claim 11, wherein said receiving the input includes receiving a user input to designate a quantity of the columns to create in the column display layout.

14. A method as recited in claim 11, wherein:
said receiving the input includes receiving a user input to designate a column width as a number of text characters; and the method further comprising:
determining a quantity of the columns to create based on the designated column width.

15. A method as recited in claim 9, wherein the Web page includes non-displayed text in an initial display of the Web page in the browser application interface; and the method further comprising:
distributing the non-displayed text into the columns of the column display layout after said redistributing the displayed text into the columns.

16. A method as recited in claim 9, further comprising:
grouping the columns of the column display layout into text pages that are sequentially navigable with page navigation inputs.

17. Computer-readable storage media comprising a text reflow browser extension stored as instructions that are executable and, responsive to execution of the instructions at a computing device, the computing device performs operations of the text reflow browser extension comprising to:
determine a size of a viewable area in which a Web page is displayed in a browser application interface, the Web page including displayable text;
determine a display orientation of the viewable area in the browser application interface;
determine a column display layout based on at least the size and the display orientation of the viewable area in the browser application interface;
create columns of the column display layout; and
redistribute the displayable text into the columns of the column display layout for display in the browser application interface.

18. Computer-readable storage media as recited in claim 17, wherein the computing device performs the operations of the text reflow browser extension further comprising to receive a user input to select a pagination format template of the column display layout.

19. Computer-readable storage media as recited in claim 17, wherein the computing device performs the operations of the text reflow browser extension further comprising to receive a user input to designate a quantity of the columns to create in the column display layout.

20. Computer-readable storage media as recited in claim 17, wherein the computing device performs the operations of the text reflow browser extension further comprising to distribute non-displayed text of the Web page into the columns of the column display layout after the displayable text is redistributed into the columns.
